(19) United States
(12) Patent Application Publication
(10) Pub. No.: US 2025/0257221 A1
(43) Pub. Date: Aug. 14, 2025

(54) PHOTOCURABLE RESIN COMPOSITION

(71) Applicant: CANON KABUSHIKI KAISHA, Tokyo (JP)

(72) Inventors: EMI OISHI, Kanagawa (JP); RYOHEI HARADA, Kanagawa (JP); JUN MIURA, Kanagawa (JP); KENICHI KANAI, Chiba (JP); KENTO TSUDA, Kanagawa (JP)

(21) Appl. No.: 19/184,162

(22) Filed: Apr. 21, 2025

Related U.S. Application Data
(63) Continuation of application No. PCT/JP2023/038515, filed on Oct. 25, 2023.

(30) Foreign Application Priority Data
Oct. 28, 2022 (JP) 2022-172965

(51) Int. Cl. C09D 4/06; B29C 64/124; B29K 33/04; B33Y 10/00; B33Y 70/00; C09D 7/61; C09D 133/14; C09D 135/02

(52) U.S. Cl. CPC C09D 4/06; B29C 64/124; B33Y 10/00; B33Y 70/00; C09D 7/61; C09D 133/14; C09D 135/02; B29K 2033/04

(57) ABSTRACT

Provided is a photocurable resin composition which can provide a cured product with flame retardance and excellent mechanical strength and is compatible with a shaping process using photocuring. The photocurable resin composition of the present invention is characterized by containing: Component (A): a radically cyclopolymerizable compound; Component (B): a polyfunctional radically polymerizable compound having a polyalkylene glycol ether skeleton and/or a diisocyanate skeleton; Component (C): a polyfunctional radically polymerizable compound; Component (D): an ammonium polyphosphate; and Component (E): a radical polymerization initiator.

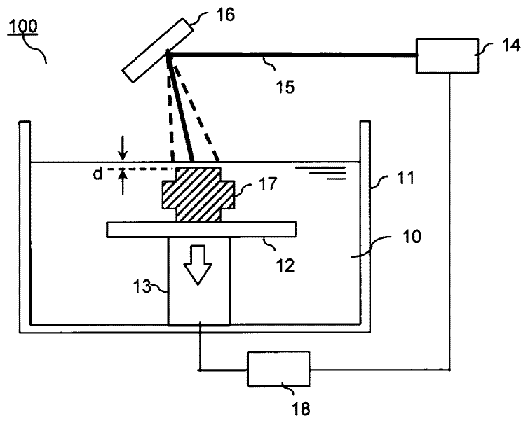

### CROSS-REFERENCE TO RELATED APPLICATIONS

This application is a Continuation of International Patent Application No. PCT/JP2023/038515, filed Oct. 25, 2023, which claims the benefit of Japanese Patent Application No. 2022-172965, filed Oct. 28, 2022, both of which are hereby incorporated by reference herein in their entirety.

### BACKGROUND OF THE INVENTION

### Field of the Invention

The present invention relates to a photocurable resin composition, a cured product and a method for producing an article.

### Description of the Related Art

In recent years, additive manufacturing (AM) processes have been increasingly used as a means of producing products against a background of diversification of shaping materials and advances in apparatus technology. The processes include a shaping process referred to as a liquid layer photopolymerization process (vat photopolymerization process) or an optical shaping process (stereolithography process). This shaping process, which forms a three-dimensional shape by curing a liquid photocurable resin with a laser beam or lamp, is characterized in that the process can perform high-definition and high-precision shaping. At the same time, shaped products produced from photocurable resins have high mechanical strength and environmental resistance and, in addition, are being improved in material properties such as flexural modulus, impact resistance and heat resistance, and in flame retardance as multi-functionalization.

Japanese Patent Application Laid-Open No. 2020-505255 describes that an ink containing a cyclopolymerizable monomer and an oligomer curable material can be used for shaping with a 3D printer to obtain a shaped product having mechanical properties similar to those of a thermoplastic resin. Japanese Patent Application Laid-Open No. 2021-146689 describes that a resin composition for stereolithography containing a urethane acrylate compound and, as a flame retardant, a salt of a compound having a guanidine structure and an inorganic oxo acid or a condensate thereof can be used to obtain a cured product having flame retardance, heat resistance, and impact resistance.

However, when a shaped product produced from a photocurable resin is used for a product such as electrical and electronic equipment, office automation equipment, a camera or a computer, high flame retardance in accordance with IEC standards, ISO standards or national standards are required. Flame retardance can be ensured by increasing the thickness of parts, but reducing the thickness of the parts is required from the viewpoint of freedom in shape, and further flameproofing is in turn required for shaping materials.

When flameproofing a resin, a halogen-free flame retardant or inorganic filler is selected from the viewpoint of reducing environmental impact. However, in the case of a resin with a high oxygen index, such as an acrylic resin, a large amount of halogen-free flame retardant or inorganic filler must be added in order to develop flame retardance, resulting in a deterioration in the mechanical strength of the shaped product.

It is an object of the present invention to provide a photocurable resin composition which can provide a cured product with flame retardance and excellent mechanical strength and is compatible with a shaping process using photocuring.

### SUMMARY OF THE INVENTION

After diligent research for achieving the above object, the present inventors have completed the present invention. That is, the photocurable composition of the present invention is a photocurable resin composition characterized by containing:
Component (A): a radically cyclopolymerizable compound;
Component (B): a polyfunctional radically polymerizable compound having a polyalkylene glycol ether skeleton and/or a diisocyanate skeleton;
Component (D): an ammonium polyphosphate; and
Component (E): a radical polymerization initiator.

Further features of the present invention will become apparent from the following description of exemplary embodiments with reference to the attached drawing.

### BRIEF DESCRIPTION OF THE DRAWINGS

FIGURE is a schematic diagram illustrating a configuration example of a shaping apparatus using a free surface process.

### DESCRIPTION OF THE EMBODIMENTS

The present embodiment relates to a photocurable resin composition containing, for example: a radically cyclopolymerizable compound that forms a polymer having a cyclic structure by radical polymerization (Component (A)); a polyfunctional radically polymerizable compound having a polyalkylene glycol ether skeleton and/or a diisocyanate skeleton (Component (B)); a polyfunctional radically polymerizable compound (Component (C)); an ammonium polyphosphate (Component (D)); and a radical polymerization initiator (Component (E)). Component (A) forms a copolymer structure by radical polymerization. Component (B) also forms a copolymer structure by radical polymerization. In the cured product after polymerization, the cyclic structure formed by polymerization of Component (A), particularly the five-membered ring ether structure, has the function of absorbing impact, achieving impact resistance. In addition to the cyclic structure formed by the polymerization of Component (A), further impact resistance is achieved when Component (B) has the function of absorbing impact. Component (C) forms a copolymer structure by radical polymerization. Component (C), in turn, forms crosslinking points by copolymerization with Component (A) and Component (B), and has the function of improving heat resistance. Component (D) has the function of developing flameproofing by promoting a stable carbonized layer mainly containing a polyphosphoric acid through a dehydration reaction during combustion. It has been found that as a result of the composition containing and preferably being compatible with a radically polymerizable compound, having a polyalkylene glycol ether skeleton or a diisocyanate skeleton, of Component (B), the dispersion stability of Component (D) is improved, and high flame retardance and impact resistance can be obtained.

### Component (A): Radically Cyclopolymerizable Compound

The radically cyclopolymerizable compound is a compound that forms a cyclic structure by intramolecular polymerization. Specific examples thereof include a 1,6-diene such as a diallyl quaternary ammonium salt, 1,6-perfluorodiene, or monofunctional 2-(allyloxymethyl)acrylic acid or its ester. From the viewpoint of compatibility with Component (B) and Component (C) or polymerization reactivity, monofunctional 2-(allyloxymethyl)acrylic acid or its ester is suitably used.

### Monofunctional 2-(Allyloxymethyl)Acrylic Acid or its Ester

The monofunctional 2-(allyloxymethyl)acrylic acid or its ester is represented by the following general formula (1):

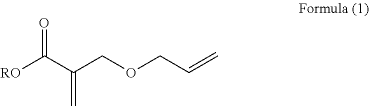

In the general formula (1), R is hydrogen or a hydrocarbon group, preferably hydrogen or a hydrocarbon group having 1 or more and 4 or less carbon atoms. The hydrocarbon group is a saturated or unsaturated hydrocarbon group, optionally having a substituent. The hydrocarbon group may be linear, branched or cyclic, and may have an ether bond.

Examples of the hydrocarbon group include a methyl group, an ethyl group, an n-propyl group, an isopropyl group, an n-butyl group, a sec-butyl group, a tert-butyl group, a vinyl group, an allyl group, a methallyl group, a crotyl group, a cyclopropyl group, a cyclobutyl group, a methoxymethyl group, a methoxyethyl group, an ethoxymethyl group, an ethoxyethyl group, a vinyloxyethyl group, an epoxy group and an oxetanyl group. The hydrocarbon group to be suitably used is particularly a hydrocarbon group having 1 or more and 2 or less carbon atoms.

Examples of the substituent which the hydrocarbon group optionally has include a chain unsaturated hydrocarbon group such as a vinyl group, an allyl group, a methallyl group or a crotyl group; a cyclic ether structure such as an epoxy group, a glycidyl group or an oxetanyl group; an alkoxy group such as a methoxy group, an ethoxy group or a methoxyethoxy group; an alkylthio group such as a methylthio group or an ethylthio group; an acyl group such as acetyl group or propionyl group; an acyloxy group such as an acetyloxy group or a propionyloxy group; an alkoxycarbonyl groups such as a methoxycarbonyl group or an ethoxycarbonyl group; an alkylthiocarbonyl group such as a methylthiocarbonyl group or an ethylthiocarbonyl group; a halogen atom such as a fluorine atom, a chlorine atom, a bromine atom or an iodine atom; a ureido group; an amide group; a cyano group; a hydroxyl group; and a trimethylsilyl group.

Examples of Component (A) to be used include a commercially available product such as AOMA (manufactured by NIPPON SHOKUBAI CO., LTD.).

The inclusion of a ring structure formed by polymerization of Component (A) improves the impact resistance of the cured product. Therefore, the content of Component (A) is suitably 10% by mass or more and 45% by mass or less, preferably 20% by mass or more and 45% by mass or less, and more preferably 20% by mass or more and 40% by mass or less, based on the total amount of the photocurable resin composition.

### Component (B): Polyfunctional Radically Polymerizable Compound Having Polyalkylene Glycol Ether Skeleton and/or Diisocyanate Skeleton

Component (B) is a compound, preferably an oligomer, having either a polyalkylene glycol ether skeleton or a diisocyanate skeleton. Component (B) preferably has two or more radically polymerizable groups. The radically polymerizable group is preferably a group having a carbon-carbon double bond, and more preferably a (meth)acryloyl group.

### Alkylene Glycol Ether

In the polyalkylene glycol ether skeleton contained in Component (B), the type of alkylene glycol includes ethylene glycol, propylene glycol, tetramethylene glycol and neopentyl glycol, and a compound added by a polyester, a polycaprolactone modification or a polycarbonate modification, which form a bond with an isocyanate group, a (meth)acrylic group or the like via an ether bond. From the viewpoint of impact resistance, the alkylene glycol ether desirably has a polyalkylene glycol structure with two or more consecutive alkylene glycols.

Examples of the alkylene glycol ether include diethylene glycol di(meth)acrylate, triethylene glycol di(meth)acrylate, tetraethylene glycol di(meth)acrylate, nonaethylene glycol di(meth)acrylate, polyethylene glycol di(meth)acrylate, polypropylene glycol di(meth)acrylate, polytetraethylene glycol di(meth)acrylate, a polyalkylene oxide adduct of dipentaerythritol penta(meth)acrylate, a polyalkylene oxide adduct of dipentaerythritol hexa(meth)acrylate bisphenol A, ethoxylated pentaerythritol tetra(methacrylate) polycaprolactone modified-di(meth)acrylate, polycarbonate diol di(meth)acrylate and polyester di(meth)acrylate.

### Compounds With Diisocyanate Skeleton

Among the compounds with a diisocyanate skeleton contained in Component (B), polyfunctional urethane (meth)acrylate can be suitably used.

### Polyfunctional Urethane (Meth)Acrylate

The polyfunctional urethane (meth)acrylate of Component (B) is a compound, preferably an oligomer, having a urethane bond and a (meth)acryloyl group. Component (B) is preferably bifunctional. Examples of Component (B) include one obtained by reacting a hydroxyl group-containing (meth)acrylate-based compound with a polyvalent isocyanate-based compound; one obtained by reacting an isocyanate group-containing (meth)acrylate-based compound with a polyol-based compound; and one obtained by reacting a hydroxyl group-containing (meth)acrylate-based compound with a polyvalent isocyanate-based compound and a polyol-based compound. Among these, one obtained by reacting a hydroxyl group-containing (meth)acrylate-based compound with a polyvalent isocyanate-based compound and a polyol-based compound is particularly preferred from the viewpoint of providing a high impact resistance.

Component (B) is preferably a polyester-based urethane (meth)acrylate containing at least an isophorone diisocyanate skeleton, a 1,4-butanediol skeleton and/or a neopentyl glycol skeleton, in which each skeleton is obtained by repeating a bond selected from the group consisting of an ester bond, an ether bond, a carbonate bond and a urethane bond, and in which both ends of the oligomer are treated with a hydroxyl group-containing (meth)acrylic acid ester, in order to achieve both heat resistance and impact resistance of the cured product. Component (B) is more preferably a polyester-based urethane (meth)acrylate containing at least an isophorone diisocyanate skeleton, a 1,4-butanediol skeleton and/or a neopentyl glycol skeleton, in which each skeleton is obtained by repeating a bond selected from the group consisting of an ester bond and a urethane bond, and in which both ends of the oligomer are treated with a hydroxyl group-containing (meth)acrylic acid ester, in order to improve impact resistance of the cured product.

The isophorone diisocyanate skeleton can form a urethane bond that contributes to an improvement in impact resistance, while its cyclic skeleton is also expected to improve heat resistance. The neopentyl glycol skeleton forms a urethane bond with the isophorone diisocyanate skeleton, contributing to an improvement in impact resistance, while its two methyl groups restrict molecular motion, contributing to an improvement in heat resistance. The 1,4-butanediol skeleton forms a urethane bond with the isophorone diisocyanate skeleton, contributing to an improvement in impact resistance, while it suppresses an increase in the viscosity of the material and appropriately forms repeating units of polyester bond, contributing to achieving both heat resistance and impact resistance.

Urethane (meth)acrylate has a molecular weight distribution when an oligomer is prepared and then (meth)acrylated. The molecular weight of the oligomer is not particularly limited as long as both heat resistance and impact resistance of the cured product are achieved, and the molecular weight is preferably 400 or more and 30,000 or less. If the molecular weight of the oligomer is low, the impact resistance may be low, whereas if the molecular weight of the oligomer is high, the heat distortion temperature may be low. Therefore, the molecular weight of the oligomer is more preferably 1,000 or more and 10,000 or less, and even more preferably 4,000 or more and 8,000 or less.

The content of Component (B) is not particularly limited as long as the cured product achieves both heat resistance and impact resistance. However, if the content of Component (B) is high, the viscosity of the photocurable resin composition may increase and the flowability of the material may be low in optical three-dimensional shaping or cast shaping, which may lead to poor shaping and increased bubble entrapment. Therefore, the content of Component (B) is preferably 10% by mass or more and 40% by mass or less, based on the total amount of the photocurable resin composition. In consideration of achieving both heat resistance and impact resistance and providing shaping stability, the content of Component (B) is more preferably 5% by mass or more and 35% by mass or less, and even more preferably 15% by mass or more and 35% by mass or less.

### Component (C): Polyfunctional Radically Polymerizable Compound

Component (C) is a polyfunctional radically polymerizable compound different from Component (B). Component (C) is also a radically polymerizable compound different from Component (A). The polyfunctional radically polymerizable compound that is Component (C) has two or more radically polymerizable groups in one molecule. The radically polymerizable group is preferably a group having a carbon-carbon double bond, and more preferably a (meth) acryloyl group. The polyfunctional radically polymerizable compound that is Component (C) preferably does not include such a polyalkylene glycol ether skeleton and/or a diisocyanate skeleton as included in Component (B). Specifically, the polyfunctional radically polymerizable compound that is Component (C) preferably has less than two and one or less alkylene glycol ether in its side chain and no diisocyanate skeleton. In particular, the polyfunctional radically polymerizable compound that is Component (C) preferably has neither a polyalkylene glycol ether skeleton nor a diisocyanate skeleton.

Examples of Component (C) include ethylene glycol di(meth)acrylate, 1,3-butylene glycol di(meth)acrylate, 1,4-butanediol di(meth)acrylate, dimethylol tricyclodecane di(meth)acrylate, trimethylolpropane tri(meth)acrylate, neopentyl glycol di(meth)acrylate, 1,6-hexamethylene di(meth)acrylate, neopentyl glycol hydroxypivalate di(meth)acrylate, pentaerythritol tri(meth)acrylate, pentaerythritol tetra(meth)acrylate, dipentaerythritol penta(meth)acrylate, tri(acryloyloxyethyl) isocyanurate, tri(methacryloyloxyethyl) isocyanurate, ε-caprolactone-modified tris-(2-acryloxyethyl) isocyanurate, di(meth)acrylate of an ε-caprolactone adduct of neopentyl glycol hydroxypivalate, a polyfunctional (meth)acrylate having fluorine atoms, and a polyfunctional (meth)acrylate having a siloxane structure.

Examples of Component (C) that can be suitably used also include a compound having an isocyanurate ring such as an isocyanurate derivative represented by the following general formula (2), from the viewpoint of achieving both heat resistance and impact resistance of the stereolithography product.

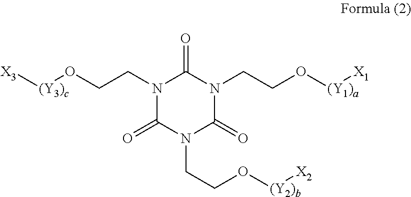

X₁ to X₃ in the general formula (2) are not particularly limited as long as both heat resistance and impact resistance of the cured product are achieved and optical three-dimensional shaping or cast shaping can be performed. Specifically, X₁ to X₃ are each independently selected from a hydrogen atom and a (meth)acryloyl group, and may be the same as or different from one another. At least two of X₁ to X₃ are preferably a (meth)acryloyl group, in order to achieve both heat resistance and impact resistance of the cured product.

Y₁ to Y₃ in the general formula (2) represent a caprolactone modification group (—C(═O)—(CH₂)₅—O—), and a to c represent a number of 0 or more and less than 2. The average value of the sum of a to c is preferably 0 or more and less than 3 and more preferably 0 or more and 1 or less from the viewpoint of heat resistance, and even more preferably 0 or more and 0.5 or less from the viewpoint of heat resistance and impact resistance.

The content of Component (C) is not particularly limited as long as the heat resistance and impact resistance of the cured product are achieved and optical three-dimensional shaping or cast shaping can be performed. If the content of Component (C) is high, the impact resistance of the cured product may be deteriorated, whereas if the content of Component (C) is low, the heat distortion temperature of the cured product may be deteriorated, and in some cases, the elastic modulus of the cured product at normal temperature may be deteriorated. In addition, the viscosity of the photocurable resin composition also changes depending on the content of Component (C). Therefore, the content of Component (C) is preferably 5% by mass or more and 50% by mass or less, based on the total amount of the photocurable resin composition. The content of Component (C) is more preferably 20% by mass or more and 40% by mass or less, in order to further achieve both heat resistance and impact resistance of the cured product and to further make it more suitable for optical three-dimensional shaping or cast shaping. When not so high heat resistance is required, such as when the cured product is used at normal temperature, Component (C) is not essential. If Component (C) is not contained, the content of Component (C) is 0% by mass. That is, the content of Component (C) is 0% by mass or more.

### Component (D): Ammonium Polyphosphate

An ammonium polyphosphate that is Component (D) is an ammonium salt of a phosphate polymer, and its polymer molecular weight is, but not particularly limited to, about 800 to 200,000. Depending on the production method thereof, Component (D) can take a crystal structure of type I, type II, type III, type IV or type V, any of which can be used.

From the viewpoint of dispersion stability in a liquid in the uncured state, the number average particle size of Component (D) is preferably 0.01 μm or more and 100 μm or less, and particularly preferably 0.01 μm or more and 20 μm or less. When the ammonium polyphosphate can be extracted, the number average particle size can be measured with a laser diffraction type-particle size distribution measuring apparatus. When the ammonium polyphosphate is contained in the cured product, the particle sizes of multiple particles can be each measured from a cross-sectional SEM image thereof, and can be calculated as an average value. Component (D) can be used whether it has been surface treated or not, but Component (D) that has not been surface treated can be suitably used, from the viewpoint of the combination of Component (D) with Component (A), Component (B) and Component (C).

The content of Component (D) is preferably 10% by mass or more and 30% by mass or less, and more preferably 15% by mass or more and 25% by mass or less, based on the total amount of the photocurable resin composition. If the content of Component (D) is low, the flame retardance may be deteriorated, whereas if the content of Component (D) is high, impact resistance may be deteriorated.

### Component (E): Radical Polymerization Initiator

The radical polymerization initiator that is Component (E) can be appropriately selected depending on curing conditions (such as irradiation wavelength or irradiation level) of the curable resin.

Examples of the polymerization initiator that generates radical species by light irradiation include, but not limited to, 2,4,6-trimethylbenzoyl-diphenylphosphine oxide, 2-benzyl-2-dimethylamino-1-(4-morpholinophenyl)-1-butanone, 1-hydroxycyclohexyl phenyl ketone, 2-hydroxy-2-methyl-1-phenyl-propan-1-one, bis(2,4,6-trimethylbenzoyl)-phenylphosphine oxide, 4-phenylbenzophenone, 4-phenoxybenzophenone, 4,4′-diphenylbenzophenone and 4,4′-diphenoxybenzophenone.

Examples of the polymerization initiator that generates radical species by heat include, but not limited to, an azo compound such as azobisisobutyronitrile (AIBN); and a peroxide such as benzoyl peroxide, tert-butyl peroxypivalate, tert-butyl peroxyneohexanoate, tert-hexyl peroxyneohexanoate, tert-butyl peroxyneodecanoate, tert-hexyl peroxyneodecanoate, cumyl peroxyneohexanoate or cumyl peroxyneodecanoate.

The radical polymerization initiator may be used alone or in combination of two or more thereof. The amount of the radical polymerization initiator to be added is preferably 0.01 parts by mass or more and 10.00 parts by mass or less, based on 100 parts by mass of the radically polymerizable compound. The addition proportion of the radical polymerization initiator may be selected depending on the light irradiation level, and even depending on the additional heating temperature. The addition proportion of the radical polymerization initiator may also be adjusted depending on the target average molecular weight of the polymer to be obtained.

### Monofunctional Radically Polymerizable Compound

A monofunctional radically polymerizable compound other than Component (A) can be added to the photocurable resin composition of the present embodiment to the extent that no significant deterioration in the performance of the cured product occurs.

Examples of the monofunctional radically polymerizable compound other than Component (A) include the following monofunctional (meth)acrylates. Examples of the monofunctional (meth)acrylate include, but not limited to, 4-tert-butylcyclohexanol (meth)acrylate, 3,3,5-trimethylcyclohexanol (meth)acrylate, isobornyl (meth)acrylate, cyclic trimethylolpropane formal (meth)acrylate, 3-hydroxy-1-(meth)acryloyloxyadamantane, 1-adamantyl (meth)acrylate, 2-methyl-2-adamantyl (meth)acrylate, 2-isopropyladamantan-2-yl (meth)acrylate, tetrahydrodicyclopentadienyl (meth)acrylate, α-(meth)acryloxy-γ-butyrolactone, 2-hydroxy-o-phenylphenolpropyl (meth)acrylate, acryloylmorpholine, diethylacrylamide, isopropylacrylamide, hydroxyethyl acrylamide, cyclohexyl (meth)acrylate, methyl (meth)acrylate, 2-ethylhexyl (meth)acrylate, lauryl (meth)acrylate, stearyl (meth)acrylate, isooctyl (meth)acrylate, tetrahydrofurfuryl (meth)acrylate, benzyl (meth)acrylate, phenoxyethyl (meth)acrylate, phenoxypolyethylene glycol (meth)acrylate, phenylglycidyl (meth)acrylate, isodecyl (meth)acrylate, tridecyl (meth)acrylate, ethoxydiethylene glycol (meth)acrylate, methoxyditripropylene glycol (meth)acrylate, tricyclodecane (meth)acrylate, dicyclopentadieneoxyethyl (meth)acrylate, dicyclopentenyl (meth)acrylate, dicyclopentenyloxyethyl acrylate, dicyclopentenyloxy (meth)acrylate, and dicyclopentanyl (meth)acrylate.

A single type of monofunctional radically polymerizable compound may be added, or multiple types of monofunctional radically polymerizable compound may be combined, to the extent that the mechanical properties of the cured product are not deteriorated. The content of the monofunctional radically polymerizable compound to the extent that the mechanical properties of the cured product are not deteriorated is suitably 5% by mass or more and 30% by mass or less, based on the total amount of the photocurable resin composition.

### Other Polymerizable Compounds

Other polymerizable materials may be added to adjust the viscosity or provide the functionalities. The other polymerizable compounds are not particularly limited, and examples thereof include a cationic polymerizable compound such as a monofunctional or bifunctional or higher functional epoxy or oxetane compound.

Examples of the monofunctional or bifunctional or higher functional epoxy and oxetane compound include, but not limited to, hydrogenated bisphenol A diglycidyl ether, hydrogenated bisphenol F diglycidyl ether, hydrogenated bisphenol AD diglycidyl ether, hydrogenated bisphenol Z diglycidyl ether, cyclohexane dimethanol diglycidyl ether, tricyclodecane dimethanol diglycidyl ether, 3,4-epoxycyclohexylmethyl-3′,4′-epoxycyclohexane carboxylate, 3,4-epoxy-1-methylcyclohexyl 3,4-epoxy-1-methylcyclohexane carboxylate, 6-methyl-3,4-epoxycyclohexylmethyl-6-methyl-3,4-epoxycyclohexane carboxylate, 3,4-epoxy-3-methylcyclohexylmethyl-3,4-epoxy-3-methylcyclohexane carboxylate, 3,4-epoxy-5-methylcyclohexylmethyl-3,4-epoxy-5-methylcyclohexane carboxylate, 2-(3,4-epoxycyclohexyl-5,5-spiro-3,4-epoxy)cyclohexane-metadioxane, bis(3,4-epoxycyclohexylmethyl)adipate, 3,4-epoxy-6-methylcyclohexyl carboxylate, dicyclopentadiene diepoxide, ethylene bis(3,4-epoxycyclohexane carboxylate), dioctyl epoxyhexahydrophthalate, di-2-ethylhexyl epoxyhexahydrophthalate, ε-caprolactone-modified 3′,4′-epoxycyclohexylmethyl 3,4-epoxycyclohexane carboxylate, a 1,2-epoxy-4-(2-oxiranyl)cyclohexane adduct of 2,2-bis(hydroxymethyl)-1-butanol, bis(3,4-epoxycyclohexyl)methane, 2,2-bis(3,4-epoxycyclohexyl)propane, 1,1-bis(3,4-epoxycyclohexyl)ethane, alpha-pinene oxide, campholenealdehyde, limonene monoxide, limonene dioxide, 4-vinylcyclohexene monoxide, 4-vinylcyclohexene dioxide, 3-hydroxymethyl-3-methyloxetane, 3-hydroxymethyl-3-ethyloxetane, 3-hydroxymethyl-3-propyloxetane, 3-hydroxymethyl-3-normal-butyloxetane, and 3-hydroxymethyl-3-propyloxetane.

The content of the other polymerizable compound is in a range that does not impair the mechanical properties of the cured product, and is suitably 5% by mass or more and 30% by mass or less, based on the total amount of the photocurable resin composition.

When a cationically polymerizable compound is added, a polymerization initiator that generates cationic species by light irradiation, a photoacid generator or a photobase generator may be added to the photocurable resin composition to promote the polymerization reaction of the cationically polymerizable compound. Suitable examples of the polymerization initiator that generates cationic species by light irradiation include, but not limited to, iodonium (4-methylphenyl) [4-(2-methylpropyl)phenyl]-hexafluorophosphate. Examples of the photoacid generator include, but not limited to, triarylsulfonium hexafluoroantimonate, triphenylphenacylphosphonium tetrafluoroborate, triphenylsulfonium hexafluoroantimonate, bis-[4-(diphenylsulfonio)phenyl]sulfide bisdihexafluoroantimonate, bis-[4-(di-4′-hydroxyethoxyphenylsulfonio)phenyl]sulfide bisdihexafluoroantimonate, bis-[4-(diphenylsulfonio)phenyl]sulfide bisdihexafluorophosphate, and diphenyliodonium tetrafluoroborate.

The amount of the polymerization initiator that generates cationic species to be added is preferably in the range of 0.01 parts by mass or more and 10.00 parts by mass or less, based on 100 parts by mass of the cationically polymerizable compound.

### Other Additives

A polymerization inhibitor, a photosensitizer, light stabilizers, a heat stabilizer, an antioxidant, a chain transfer agent, a curing aid, or the like can be added to the photocurable resin composition of the present embodiment to the extent that no significant deterioration in performance of the cured product occurs.

Examples of the polymerization inhibitor include a hydroquinone-based polymerization inhibitor such as hydroquinone, hydroquinone monomethyl ether, hydroquinone monoethyl ether, hydroquinone monopropyl ether, hydroquinone monobutyl ether, hydroquinone monopentyl ether, hydroquinone monohexyl ether, hydroquinone monooctyl ether or hydroquinone monoheptyl ether, and a phenol-based polymerization inhibitor having a substituent such as 3-(3,5-di-tert-butyl-4-hydroxyphenyl)propionate. However, the hydroquinone-based polymerization inhibitor such as hydroquinone and the benzoquinone-based polymerization inhibitor such as benzoquinone may cause yellowing upon UV irradiation, and are therefore suitable when obtaining a thin-film cured product such as a coating. Examples of the polymerization inhibitor to be used in reaction or storage include, but are not limited to, those described above. The amount of the polymerization inhibitor to be added is preferably in the range of 0.01% by mass or more and 1.00% by mass or less, based on the total amount of the photocurable resin composition. The polymerization inhibitor may be used alone or in combination of two or more thereof. In consideration of low coloration, specifically, a combination of hydroquinone-based polymerization inhibitors is preferably used.

Examples of the photosensitizer include benzophenone, 4,4-diethylaminobenzophenone, 1-hydroxycyclohexyl phenyl ketone, isoamyl p-dimethylaminobenzoate, methyl 4-dimethylaminobenzoate, benzoin, benzoin ethyl ether, benzoin isobutyl ether, benzoin isopropyl ether, 2,2-diethoxyacetophenone, methyl o-benzoylbenzoate, 2-hydroxy-2-methyl-1-phenylpropan-1-one, and acylphosphine oxide. The amount of the photosensitizer to be added is preferably in the range of 0.01% by mass or more and 10.00% by mass or less, based on the total amount of the photocurable resin composition.

The light stabilizer is not particularly limited as long as the light stabilizer does not significantly affect the properties of the cured product. Examples of the light stabilizer include a benzotriazole-based compounds, such as 2-(2H-benzotriazol-2-yl)-p-cresol, 2-(2H-benzotriazol-2-yl)-4,6-bis(1-methyl-1-phenylethyl)phenol, 2-[5-chloro(2H)-benzotriazol-2-yl]-4-methyl-6-(tert-butyl)phenol, 2-(2H-benzotriazol-2-yl)-4,6-di-tert-pentylphenol, 2-(2H-benzotriazol-2-yl)-4-(1,1,3,3-tetramethylbutyl)phenol, 2,2′-methylenbis[6-(2H-benzotriazol-2-yl)]-4-(1,1,3,3-tetramethylbutyl)phenol or 2-(2H-benzotriazol-2-yl)-6-dodecyl-4-methylphenol; a cyanoacrylate-based compound such as ethyl 2-cyano-3,3-diphenylacrylate or 2-ethylhexyl 2-cyano-3,3-diphenylacrylate; a triazine-based compound; and a benzophenone-based compound such as octabenzone or 2,2′,4,4′-tetrahydrobenzophenone. The light stabilizers may sometimes play the role of a photosensitizer. In such a case, the photosensitizer does not need to be added. The amount of the light stabilizer to be added is preferably in the range of 0.01% by mass or more and 10.00% by mass or less, based on the total amount of the photocurable resin composition.

The heat stabilizer is not particularly limited as long as the heat stabilizer does not significantly affect the properties of the cured product. Examples of the heat stabilizer include an alkyl ester having 7 to 9 carbon atoms with a side chain of pentaerythritol tetrakis[3-(3,5-di-tert-butyl-4-hydroxyphenyl)]propionate, octadecyl-3-(3,5-di-tert-butyl-4-hydroxyphenyl)propionate, or 3,5-bis(1, 1-dimethylethyl)-4-hydroxybenzenepropanoic acid; a hindered phenol-based compound such as 4,6-bis(octylthiomethyl)-o-cresol, 4,6-bis(dodecylthiomethyl)-o-cresol, ethylene bis(oxyethylene) bis[3-(5-tert-butyl-4-hydroxy-m-tolyl)]propionate, or hexamethylene bis[3-(3,5-di-tert-butyl-4-hydroxyphenyl)]propionate; a phosphorus-based compound such as tris(2,4-di-tert-butylphenyl)phosphite; and a sulfur-based compound such as dioctadecyl-3,3′-thiodipropionate. The amount of the heat stabilizer to be added is preferably in the range of 0.01% by mass or more and 10.00% by mass or less, based on the total amount of the photocurable resin composition.

The antioxidant is not particularly limited as long as the antioxidant does not significantly affect the properties of the cured product. Examples of the antioxidant include a hindered amine-based compound such as bis(2,2,6,6-tetramethyl-4-piperidyl) sebacate or bis(1,2,2,6,6-pentamethyl-4-piperidyl) [[3,5-bis(1,1-dimethylethyl)-4-hydroxyphenyl]methyl]butylmalonate. The amount of the antioxidant to be added is preferably in the range of 0.01% by mass or more and 10.00% by mass or less, based on the total amount of the photocurable resin composition.

Examples of the chain transfer agent and the curing aid include β-mercaptopropionic acid, 2-ethylhexyl-3-mercaptopropionate, n-octyl-3-mercaptopropionate, methoxybutyl-3-mercaptopropionate, stearyl-3-mercaptopropionate, 1-butanethiol, cyclohexanethiol, cyclohexyl 3-mercaptopropionate, 1-decanethiol, 2,4-diphenyl-4-methyl-1-pentene, 1-dodecanethiol, dodecyl 3-mercaptopropionate, 2-ethylhexyl mercaptoacetate, 2-ethylhexyl 3-mercaptopropionate, ethyl mercaptoacetate, 1-hexadecanethiol, hexyl 3-mercaptopropionate, 2-mercaptoethanol, 3-mercapto-1,2-propanediol, mercaptoacetic acid, sodium 2-mercaptoethanesulfonate, 3-mercaptopropionic acid, methyl mercaptoate, mercaptosuccinic acid, methyl 3-mercaptopropionate, octadecyl 3-mercaptopropionate, octyl 3-mercaptopropionate, 1-octanethiol, 1-octadecanethiol, tridecyl 3-mercaptopropionate and thiophenol; and as a polyfunctional thiol, bis(2-mercaptoethyl)sulfide, 3,6-dioxa-1,8-octanedithiol, trimethylolpropane tris(3-mercaptopropionate), 1,4-butanediol bis(thioglycolate), pentaerythritol tetra(3-mercaptopropionate), 1,4-benzenethiol, 3,7-dithia-1,9-nonanol, DL-1,4-dimercapto-2,3-butanediol, 1,5-dimercaptonaphthalene, dithioerythritol, ethylene bisthioglycolate, pentaerythritol tetrakis(mercaptoacetate), tris-[(3-mercaptopropionyloxyethyl)-isocyanurate, tetraethylene glycol bis(3-mercaptopropionate), dipentaerythritol hexakis(3-mercaptopropionate), 3,3′-thiodipropionic acid, dithiodipropionic acid and laurylthiopropionic acid (dodecylthiopropionic acid); and as a commercially available product, TS-G, C3TS-G, TA-G and LDAIC (manufactured by SHIKOKU CHEMICALS CORPORATION) and Karenz MTPE1, BD1, NR1 and TPMB (manufactured by Showa Denko K.K.). The amount of the chain transfer agent or the curing aid to be added is preferably in the range of 0.01% by mass or more and 10.00% by mass or less, based on the total amount of the photocurable resin composition.

A pigment, a filler or the like may be also added to adjust the viscosity or impart the functionalities. The filler is not particularly limited as long as the filler does not deteriorate the mechanical properties of the cured product. The type of filler includes a metal salt, a metal oxide, a polymer fine particle, a rubber particle, an inorganic fiber, an organic fiber and a carbon. Examples of the metal oxide include, but not limited to, silicon oxide, titanium oxide and aluminum oxide. Examples of the polymer fine particle include, but not limited to, an acrylic fine particle, a polystyrene fine particle and a nylon particle. Examples of the rubber particle include, but not limited to, a butadiene rubber particle, a styrene-butadiene rubber copolymer particle, a acrylonitrile-butadiene copolymer rubber particle, or a saturated rubber particles obtained by hydrogenating or partially hydrogenating such a diene rubber, a crosslinked butadiene rubber particle, an isoprene rubber particle, a chloroprene rubber particle, a natural rubber particle, a silicone rubber particle, an ethylene/propylene/diene monomer terpolymer rubber particle, an acrylic rubber particle, and an acrylic/silicone composite rubber particle. Examples of the organic fiber include, but not limited to, a nylon fiber and a cellulose nanofiber. The content thereof may be in a range that does not impair the mechanical properties of the photocurable resin composition, and is preferably 0.01% by mass or more and 30% by mass or less, based on the total amount of the photocurable resin composition.

### Method of Preparing Photocurable Resin Composition

The method of preparing a photocurable resin composition is not particularly limited, and the simplest method thereof is to weigh all materials followed by heating and stirring them. However, if there is a concern about polymerization by heating, a polymerization inhibitor may be added as appropriate. If mixing uniformly by heating alone is difficult, the photocurable resin composition may be prepared by dissolving all materials in a solvent such as acetone followed by distilling off the solvent. In addition, stirring may be performed with a dispersing machine such as an ultrasonic homogenizer, a ball mill or a disk mill.

### Method of Shaping Article

In a step of curing the photocurable resin composition, the shape of the cured product and the curing process are not particularly limited. Examples of the curing process include a process of applying a photocurable resin composition onto a substrate followed by light irradiation; a process of injecting a photocurable resin composition into a mold followed by light irradiation; and an optical three-dimensional shaping process (stereolithography) including layer-by-layer growth of thin films of the cured product.

The process of applying a photocurable resin composition onto a substrate is not particularly limited. For example, the photocurable resin composition may be applied onto a substrate to a desired film thickness with a contact transfer type coating apparatus such as a roll coater, a reverse coater, a bar coater or a slit coater, or a non-contact type coating apparatus such as a spinner (a rotary coating apparatus) or a curtain flow coater to form a coating film. The stereolithography using the photocurable resin composition of the present invention can be performed using any of the conventionally known stereolithography processes and apparatuses. The process is preferably a process including repeating, multiple times, a step of photocuring the photocurable resin composition at a predetermined thickness to form a cured layer leading to layer-by-layer growth. Typical examples of the preferred stereolithography process include a process including repeating, multiple times, a step of supplying a photocurable resin composition at a predetermined thickness and a step of curing the photocurable resin composition at a predetermined thickness on the basis of the slice data generated based on three-dimensional shape data of the object to be produced (three-dimensional model).

The stereolithography process is roughly divided into two types: a free surface process and a regulated liquid level process.

FIGURE illustrates a configuration example of a shaping apparatus 100 using a free surface process. The shaping apparatus 100 has a tank 11 that contains a liquid photocurable resin composition 10. The tank 11 is provided inside with a shaping stage 12, in a manner that the shaping stage 12 can be driven in a vertical direction by a drive shaft 13. An active energy light ray 15 for curing the photocurable resin composition 10 emitted from a light source 14 is changed in an irradiation position by a galvanometer mirror 16 and scanned on the surface of the tank 11. In FIGURE, the scanning range is illustrated by heavy dashed lines. A galvanometer mirror 16 is controlled by a controller 18 according to the slice data.

The thickness d of the photocurable resin composition 10 to be cured by the active energy light ray 15 is a value determined based on the settings at the time of generating the slice data, and influences the accuracy of the obtained article (the reproducibility of the three-dimensional shape data of the article to be shaped). The controller 18 controls the drive amount of the drive shaft 13 so as to achieve a thickness d.

First, the controller 18 controls the drive shaft 13 based on the settings thereof, and the photocurable resin composition is supplied onto the shaping stage 12 at a thickness d. The liquid photocurable resin composition on the shaping stage 12 is irradiated with the active energy light ray 15 based on slice data so as to obtain a cured layer having a desired pattern, to form a cured layer. Then, the shaping stage 12 is moved in the direction of the open arrow, and an uncured photocurable resin composition is supplied at a thickness d to the surface of the cured layer. Thereafter, based on the slice data, the uncured photocurable resin composition is irradiated with the active energy light rays 15 to form a cured product integrated with the previously formed cured layer. This step of curing the photocurable resin composition in the form of a layer can be repeated to obtain a desired three-dimensional shaped product 17.

When the surface of the photocurable resin composition is irradiated with an active energy light ray to form a cured layer having a predetermined shape pattern, a light energy ray focused in the form of a point or line can be used to cure the resin in a pointillist or line drawing manner. Alternatively, an active energy light ray may be irradiated in a planar manner through a planar drawing mask, formed by arranging a plurality of micro light shutters such as liquid crystal shutters and digital micromirror shutters to cure the resin.

Similar to shaping by a free surface process, shaping by a regulated liquid level process is also preferred. A shaping apparatus using a regulated liquid level process is configured such that a shaping stage 12 of a shaping apparatus 100 in FIGURE is provided so as to raise a shaped product 17 above the liquid level, and a light irradiation unit is provided below a tank 11. A typical shaping example by the regulated liquid level process is as follows. First, the support surface of a support stage, which is provided so as to be freely raised and lowered, and the bottom surface of a tank containing a photocurable resin composition are located so as to be at a predetermined distance, and the photocurable resin composition is supplied between the support surface of the support stage and the bottom surface of the tank. Then, light is selectively irradiated from the bottom side of the tank containing the photocurable resin composition to the photocurable resin composition between the support surface of the support stage and the bottom surface of the tank, according to the slice data by a laser light source or a projector. The photocurable resin composition between the support surface of the support stage and the bottom surface of the tank is cured by light irradiation to form a solid cured layer. Thereafter, the cured layer is peeled away from the bottom of the tank by raising the support stage.

Subsequently, the height of the support stage is adjusted so that the distance between the cured layer formed on the support stage and the bottom of the tank is a predetermined distance. Thereafter, in the same manner as above, the photocurable resin composition is supplied between the bottom of the tank and the cured layer and irradiated with light according to the slice data to form a new cured layer between the bottom of the tank and the cured layer. This step can be repeated multiple times to obtain a shaped product 17 in which multiple cured layers are integrally grown.

The shaped product 17 thus obtained can be taken out of the tank 11, and be freed of any unreacted photocurable resin composition remaining on the surface of the shaped product and then be subjected to post-processing as necessary, to obtain a desired article.

Examples of the post-processing include washing, post curing, cutting, polishing and assembling.

Examples of a washing agent that can be used for washing include an alcohol-based organic solvent represented by isopropyl alcohol or ethyl alcohol. Other examples of the washing agent that may be used include a ketone-based organic solvent represented by acetone, ethyl acetate or methyl ethyl ketone, and an aliphatic organic solvent represented by a terpene.

After washing, the shaped product may be subjected to post-curing by light irradiation, heat irradiation, or both, as necessary. Post-curing can cure any unreacted photocurable resin composition which may remain on the surface of and inside the shaped product, suppress stickiness of the surface of the three-dimensional shaped product and, in addition, improve the initial strength of the three-dimensional shaped product.

Examples of the active energy light rays can include an ultraviolet ray, an electron ray, an X-ray, a radioactive ray and a high frequency wave. Among them, ultraviolet rays with a wavelength of 300 nm to 430 nm are preferably used because of their high versatility. As a light source for such ultraviolet rays, an ultraviolet laser (such as a semiconductor-pumped solid-state laser, an Ar laser or a He—Cd laser), a high-pressure mercury lamp, an ultrahigh-pressure mercury lamp, a mercury lamp, a xenon lamp, a halogen lamp, a metal halide lamp, an ultraviolet LED (light-emitting diode), a fluorescent lamp, or the like can be used. In particular, the ultraviolet laser is preferably used, because it is excellent in light-condensing properties, can increase the energy level to reduce the shaping time and can provide high shaping accuracy.

### Uses

The photocurable resin composition of the present invention can be suitably used in an additive manufacturing (AM) process, and particularly in a stereolithography process. In addition, the cured product and the shaped product obtained by a 3D printer, of the present invention, can be widely used in the field of optical three-dimensional shaping. The application field is not limited in any way, but typical examples thereof include a prototype model, a design model, a working model, a base model for producing a mold, a direct mold for a prototype mold, a service part and a housing, of an industrial product including such a product as electrical and electronic equipment, office automation equipment, a camera or a computer; as well as a component of an industrial product. The photocurable resin composition of the present invention can be used particularly for the production such as an industrial product or component in which flame retardance and impact resistance are required.

### EXAMPLES

### Examples 1 to 19 and Comparative Examples 1 to 5

### Components

The components used in Examples and Comparative Examples are each shown in Table 1.

TABLE 1

| | | Compound name | Company name | Product name |
|---|---|---|---|---|
| Component | A-1 | methyl 2-(allyloxy)acrylate | NIPPON SHOKUBAI CO., | FX-AO-MA |
| (A) | | | LTD. | |
| Component | B-1 | Polyfunctional urethane acrylate | Nippon Kayaku Co., Ltd. | KAYARAD UX- |
| (B) | | Polyester-based urethane acrylate | | 6101 |
| | | having isophorone diisocyanate | | |
| | | skeleton, 1,4-butanediol skeleton and | | |
| | | neopentyl glycol skeleton | | |
| | B-2 | Polyfunctional urethane acrylate | Sartomer | CN-9001 |
| | B-3 | Polyfunctional urethane acrylate | Toagosei | M-1100 |
| | B-4 | Polyfunctional urethane acrylate | SHIN-NAKAMURA | UA-160TM |
| | | | CHEMICAL Co., Ltd. | |
| | B-5 | Polyfunctional urethane acrylate | SHIN-NAKAMURA | UA-290TM |
| | | | CHEMICAL Co., Ltd. | |
| | B-6 | Polyethylene glycol diacrylate | SHIN-NAKAMURA | A-1000 |
| | | Ethylene glycol skeleton n = 23 | CHEMICAL Co., Ltd. | |
| | B-7 | Ethoxylated pentaerythritol | SHIN-NAKAMURA | ATM-35E |
| | | tetraacrylate | CHEMICAL Co., Ltd. | |
| | | Ethylene glycol skeleton n = 35 | | |
| | B-8 | Polytetramethylene glycol diacrylate | SHIN-NAKAMURA | APTMG-75 |
| | | Tetramethylene glycol skeleton | CHEMICAL Co., Ltd. | |
| | | n = 9 | | |
| Component | C-1 | Tris(2-acryloxyethyl) isocyanurate | SHIN-NAKAMURA | A-9300S |
| (C) | | | CHEMICAL Co., Ltd. | |
| Component | D-1 | Ammonium polyphosphate | Clariant AG | ExolitAP423 |
| (D) | | (Number average particle size: 8 μm) | | |
| | D-2 | Ammonium polyphosphate | SUZUHIRO CHEMICAL CO., | FCP-790 |
| | | (Number average particle size: 15 μm) | LTD. | |
| Component | E-1 | Bis(2,4,6-trimethylbenzoyl)phenyl | I.G.M Resins | Omnirad819 |
| (E) | | phosphate oxide | | |
| Component | F-1 | Condensed phosphate ester | DAIHACHI CHEMICAL | DAIGUARD880 |
| (F) | | | INDUSTRY CO., LTD. | |
| | F-2 | Melamine polyphosphate | Mitsui Fine Chemicals, Inc. | Planelon NP |

### Production of Photocurable Resin Composition

The components were formulated in the formulation proportions shown in Tables 2-1, 2-2 and 2-3, and mixed uniformly. The formulation proportion (composition) shown in Tables 2-1, 2-2 and 2-3 is expressed as a percentage by mass based on the total amount of the photocurable resin composition.

### Production of Cured Product for Test Specimen

A cured product was prepared using the prepared photocurable resin composition by the following method. A 3D printer (product name “Foto 8.9”, manufactured by Flashforge) was used to grow layer-by-layer the photocurable resin composition in the width direction of a test specimen at a thickness of 100 μm and an irradiation time per layer of 10 seconds as a primary curing to prepare a cured product. The cured product was washed with an organic solvent and subjected to a secondary curing treatment for one hour with a secondary curing apparatus (product name “Formcure”, manufactured by Formlabs). Furthermore, the product was placed in a heating oven at 100° C. and was subjected to heat treatment for one hour to obtain a cured product for a test specimen.

### Evaluation for Flame Retardance

Each of the prepared test specimens (length: 125 mm, width: 13 mm, thickness: 1.5 mm or 3 mm) was used to determine V-0, V-1 and V-2 from the afterflame time or afterglow time of a sample after flame contact, and the presence or absence of combusted product or fallen objects, based on the UL94-20 mm vertical flammability test. Rating A is better than Rating B and Rating B is better than Rating C.
A: V-1 or V-0 at a test specimen thickness of 1.5 mm.
B: V-1 or V-0 at a test specimen thickness of 3 mm.
C: Combusted, no rating.

### Evaluation for Impact Resistance

Each of the prepared test specimens (length: 80 mm, width: 10 mm, thickness: 4 mm) was used to make a 45° notch of 2 mm in depth in the center thereof with a notch forming machine (product name “Notching Tool A-4”, manufactured by Toyo Seiki Seisaku-sho, Ltd.) in accordance with JIS K 7111. Thereafter, the test specimen was fractured from the back of the notch at an energy of 2 J with an impact tester (product name “IMPACT TESTER IT”, manufactured by Toyo Seiki Seisaku-sho, Ltd.). The energy required for fracture was calculated from the angle at which the hammer, which had been swung up to 150°, swung up after the fracturing the test specimen, and this Charpy impact strength was used as an index of impact resistance. Impact resistance was evaluated according to the following criteria. Rating A is better than Rating B and Rating B is better than Rating C.
A: Charpy impact strength of 3 kJ/m² or more.
B: Charpy impact strength of 1 kJ/m² or more and less than 3 kJ/m².
C: Charpy impact strength of less than 1 kJ/m².

### Evaluation for Heat Resistance

Each of the prepared test specimens (length: 80 mm, width: 10 mm, thickness: 4 mm) was used to measure the deflection temperature under load with an HDT tester (manufactured by Toyo Seiki Seisaku-sho, Ltd.) in accordance with JIS 7191-1 Method A and JIS 7111-1. The deflection temperature under load was evaluated according to the following criteria. Rating A is better than Rating B and Rating B is better than Rating C.
A: Deflection temperature under load is 70° C. or more.
B: Deflection temperature under load is 50° C. or more and less than 70° C.
C: Deflection temperature under load is less than 50° C.

### Overall Evaluation

A: A has been obtained in all of evaluations for flame retardance, impact resistance and heat resistance.
B: A or B has been obtained in evaluations for flame retardance, impact resistance and heat resistance and B has been obtained in one or more of them.
C: A or B has been obtained in evaluations for flame retardance and impact resistance, and C has been obtained in an evaluation for heat resistance.
D: C has been obtained in one or more of evaluations for flame retardance and impact resistance.

TABLE 2-1

| | | | Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Composition | Component | A-1 | 20.33 | 20.33 | 20.33 | 20.33 | 24.39 | 24.39 | 37.59 | 37.59 | 37.59 | 18.80 | 32.52 |
| [wt %] | (A) | | | | | | | | | | | | |
| | Component | B-1 | 28.46 | 28.46 | 0.00 | 0.00 | 0.00 | 0.00 | 0.00 | 0.00 | 0.00 | 26.32 | 16.26 |
| | (B) | B-2 | 0.00 | 0.00 | 28.46 | 0.00 | 0.00 | 0.00 | 0.00 | 0.00 | 0.00 | 0.00 | 0.00 |
| | | B-3 | 0.00 | 0.00 | 0.00 | 28.46 | 0.00 | 0.00 | 0.00 | 0.00 | 0.00 | 0.00 | 0.00 |
| | | B-4 | 0.00 | 0.00 | 0.00 | 0.00 | 24.39 | 0.00 | 0.00 | 0.00 | 0.00 | 0.00 | 0.00 |
| | | B-5 | 0.00 | 0.00 | 0.00 | 0.00 | 0.00 | 24.39 | 0.00 | 0.00 | 0.00 | 0.00 | 0.00 |
| | | B-6 | 0.00 | 0.00 | 0.00 | 0.00 | 0.00 | 0.00 | 18.80 | 0.00 | 0.00 | 0.00 | 0.00 |
| | | B-7 | 0.00 | 0.00 | 0.00 | 0.00 | 0.00 | 0.00 | 0.00 | 18.80 | 0.00 | 0.00 | 0.00 |
| | | B-8 | 0.00 | 0.00 | 0.00 | 0.00 | 0.00 | 0.00 | 0.00 | 0.00 | 18.80 | 0.00 | 0.00 |
| | Component | C-1 | 32.52 | 32.52 | 32.52 | 32.52 | 32.52 | 32.52 | 18.80 | 18.80 | 18.80 | 30.08 | 32.52 |
| | (C) | | | | | | | | | | | | |
| | Component | D-1 | 16.26 | 0.00 | 16.26 | 16.26 | 16.26 | 16.26 | 22.56 | 22.56 | 22.56 | 22.56 | 16.26 |
| | (D) | D-2 | 0.00 | 16.26 | 0.00 | 0.00 | 0.00 | 0.00 | 0.00 | 0.00 | 0.00 | 0.00 | 0.00 |
| | Component | E-1 | 2.43 | 2.43 | 2.43 | 2.43 | 2.44 | 2.44 | 2.26 | 2.26 | 2.26 | 2.24 | 2.44 |
| | (E) | | | | | | | | | | | | |
| | Component | F-1 | 0.00 | 0.00 | 0.00 | 0.00 | 0.00 | 0.00 | 0.00 | 0.00 | 0.00 | 0.00 | 0.00 |
| | (F) | F-2 | 0.00 | 0.00 | 0.00 | 0.00 | 0.00 | 0.00 | 0.00 | 0.00 | 0.00 | 0.00 | 0.00 |

| | | | | | | | | | | | | |
|---|---|---|---|---|---|---|---|---|---|---|---|---|
| Evaluation | Overall evaluation | A | A | A | A | A | A | A | A | A | A | A |
| | Flame retardance | A | A | A | A | A | A | A | A | A | A | A |
| | Impact resistance | A | A | A | A | A | A | A | A | A | A | A |
| | Heat resistance | A | A | A | A | A | A | A | A | A | A | A |

TABLE 2-2

| | | | Example | | | | | | | |
|---|---|---|---|---|---|---|---|---|---|---|
| | | | 12 | 13 | 14 | 15 | 16 | 17 | 18 | 19 |
| Composition | Component | A-1 | 30.08 | 24.39 | 40.98 | 21.19 | 33.83 | 34.97 | 20.33 | 36.58 |
| [wt %] | (A) | | | | | | | | | |
| | Component | B-1 | 15.04 | 32.52 | 8.20 | 29.66 | 11.28 | 6.99 | 36.59 | 44.71 |
| | (B) | B-2 | 0.00 | 0.00 | 0.00 | 0.00 | 0.00 | 0.00 | 0.00 | 0.00 |
| | | B-3 | 0.00 | 0.00 | 0.00 | 0.00 | 0.00 | 0.00 | 0.00 | 0.00 |
| | | B-4 | 0.00 | 0.00 | 0.00 | 0.00 | 0.00 | 0.00 | 0.00 | 0.00 |
| | | B-5 | 0.00 | 0.00 | 0.00 | 0.00 | 0.00 | 0.00 | 0.00 | 0.00 |
| | | B-6 | 0.00 | 0.00 | 0.00 | 0.00 | 0.00 | 0.00 | 0.00 | 0.00 |
| | | B-7 | 0.00 | 0.00 | 0.00 | 0.00 | 0.00 | 0.00 | 0.00 | 0.00 |
| | | B-8 | 0.00 | 0.00 | 0.00 | 0.00 | 0.00 | 0.00 | 0.00 | 0.00 |
| | Component | C-1 | 30.08 | 24.39 | 32.79 | 33.90 | 30.08 | 27.97 | 24.39 | 0.00 |
| | (C) | | | | | | | | | |
| | Component | D-1 | 22.56 | 16.26 | 15.57 | 12.71 | 22.56 | 27.97 | 16.26 | 16.26 |
| | (D) | D-2 | 0.00 | 0.00 | 0.00 | 0.00 | 0.00 | 0.00 | 0.00 | 0.00 |
| | Component | E-1 | 2.24 | 2.44 | 2.46 | 2.54 | 2.25 | 2.10 | 2.43 | 2.45 |
| | (E) | | | | | | | | | |
| | Component | F-1 | 0.00 | 0.00 | 0.00 | 0.00 | 0.00 | 0.00 | 0.00 | 0.00 |
| | (F) | F-2 | 0.00 | 0.00 | 0.00 | 0.00 | 0.00 | 0.00 | 0.00 | 0.00 |

| | | | | | | | | | |
|---|---|---|---|---|---|---|---|---|---|
| Evaluation | Overall evaluation | A | A | B | B | B | B | B | C |
| | Flame retardance | A | A | B | B | B | A | A | A |
| | Impact resistance | A | A | A | A | A | B | B | A |
| | Heat resistance | A | A | A | A | A | A | B | C |

TABLE 2-3

| | | | Comparative Example | | | | |
|---|---|---|---|---|---|---|---|
| | | | 1 | 2 | 3 | 4 | 5 |
| Composition | Component | A-1 | 24.27 | 20.33 | 20.33 | 41.35 | 0.00 |
| [wt %] | (A) | | | | | | |
| | Component | B-1 | 33.98 | 28.46 | 28.46 | 0.00 | 44.72 |
| | (B) | B-2 | 0.00 | 0.00 | 0.00 | 0.00 | 0.00 |
| | | B-3 | 0.00 | 0.00 | 0.00 | 0.00 | 0.00 |
| | | B-4 | 0.00 | 0.00 | 0.00 | 0.00 | 0.00 |
| | | B-5 | 0.00 | 0.00 | 0.00 | 0.00 | 0.00 |
| | | B-6 | 0.00 | 0.00 | 0.00 | 0.00 | 0.00 |
| | | B-7 | 0.00 | 0.00 | 0.00 | 0.00 | 0.00 |
| | | B-8 | 0.00 | 0.00 | 0.00 | 0.00 | 0.00 |
| | Component | C-1 | 38.84 | 32.52 | 32.52 | 33.83 | 36.58 |
| | (C) | | | | | | |
| | Component | D-1 | 0.00 | 0.00 | 0.00 | 22.56 | 16.26 |
| | (D) | D-2 | 0.00 | 0.00 | 0.00 | 0.00 | 0.00 |
| | Component | E-1 | 2.91 | 2.44 | 2.44 | 2.26 | 2.44 |
| | (E) | | | | | | |
| | Component | F-1 | 0.00 | 16.26 | 0.00 | 0.00 | 0.00 |
| | (F) | F-2 | 0.00 | 0.00 | 16.26 | 0.00 | 0.00 |

| | | | | | | |
|---|---|---|---|---|---|---|
| Evaluation | Overall evaluation | D | D | D | D | D |
| | Flame retardance | C | C | C | C | A |
| | Impact resistance | A | B | B | B | C |
| | Heat resistance | B | B | B | A | A |

Tables 2-1, 2-2 and 2-3 show that the cured products of Examples 1 to 19 are highly flame retardant when compared to the cured products of Comparative Example 1 which does not contain Component (D), Comparative Example 2 which contains a condensed phosphoric ester (F-1) instead of Component (D), Comparative Example 3 which contains melamine polyphosphate (F-2) instead of Component (D) and Comparative Example 4 which does not contain Component (B). Tables 2-1, 2-2 and 2-3 also show that the cured products of Examples 1 to 18 which contain Component (C) are highly heat resistant when compared to the cured product of Example 19 which does not contain Component (C). In Comparative Example 5 which does not contain Component (A), the cured product required for evaluation by 3D printer shaping could not be obtained, because the viscosity of the photocurable resin composition was high, resulting in poor shaping when shaped with a 3D printer. In Example 19 which does not contain Component (C), the cured product required for evaluation by 3D printer shaping could not be obtained, because the elastic modulus of the primary cured product composition was low, resulting in poor shaping when shaped with a 3D printer. However, for Comparative Example 5 and Example 19, the test specimen prepared by cast shaping by pouring the resin composition into a mold having a cavity of the same shape as the test specimen shaped by a 3D printer could be evaluated.

As described above, a shaped product with high flame retardance and excellent impact and heat resistance can be obtained.

According to the present invention, a shaped product having high flame retardance and high mechanical strength can be achieved by a shaping process using photocuring.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A photocurable resin composition comprising:
Component (A): a radically cyclopolymerizable compound;
Component (B): a polyfunctional radically polymerizable compound having a polyalkylene glycol ether skeleton and/or a diisocyanate skeleton;
Component (D): an ammonium polyphosphate; and
Component (E): a radical polymerization initiator.

2. The photocurable resin composition according to claim 1, characterized in that Component (A) is a 1,6-diene compound and has an ether bond in its structure.

3. The photocurable resin composition according to claim 1, characterized in that Component (A) is monofunctional 2-(allyloxymethyl)acrylic acid or an ester thereof and has a structure represented by the following general formula (1): 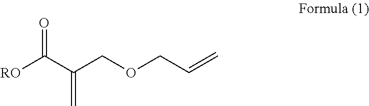
wherein R is a hydrogen atom or a hydrocarbon group.

4. The photocurable resin composition according to claim 3, characterized in that R is a hydrogen atom or a hydrocarbon group having 1 or more and 4 or less carbon atoms.

5. The photocurable resin composition according to claim 1, characterized in that Component (B) is a polyfunctional urethane (meth)acrylate having a diisocyanate skeleton.

6. The photocurable resin composition according to claim 1, characterized in that Component (B) is a polyester-based urethane (meth)acrylate having at least an isophorone diisocyanate skeleton, a 1,4-butanediol skeleton and/or a neopentyl glycol skeleton.

7. The photocurable resin composition according to claim 1, characterized in that the content of Component (B) is 10% by mass or more and 40% by mass or less, based on the total amount of the photocurable resin composition.

8. The photocurable resin composition according to claim 1, characterized in that the content of Component (D) is 10% by mass or more and 30% by mass or less, based on the total amount of the photocurable resin composition.

9. The photocurable resin composition according to claim 1, characterized in that the content of Component (A) is 10% by mass or more and 45% by mass or less, based on the total amount of the photocurable resin composition.

10. The photocurable resin composition according to claim 1, characterized by comprising Component (C): a polyfunctional radically polymerizable compound different from Component (B).

11. The photocurable resin composition according to claim 10, characterized in that the content of Component (C) is 5% by mass or more and 50% by mass or less, based on the total amount of the photocurable resin composition.

12. The photocurable resin composition according to claim 10, characterized in that Component (C) has a (meth)acryloyl group.

13. The photocurable resin composition according to claim 10, characterized in that Component (C) is a polyfunctional radically polymerizable compound that does not have a polyalkylene glycol ether skeleton and/or a diisocyanate skeleton.

14. The photocurable resin composition according to claim 10, characterized in that Component (C) is a polyfunctional radically polymerizable compound that does not have a polyalkylene glycol ether skeleton and a diisocyanate skeleton.

15. The photocurable resin composition according to claim 10, characterized by comprising a compound having an isocyanurate ring as Component (C).

16. A cured product, obtained by curing the photocurable resin composition according to claim 1.

17. A method for producing an article, comprising repeating, multiple times, photocuring the photocurable resin composition according to claim 1 at a predetermined thickness to form a cured layer.

18. The method for producing an article according to claim 17, characterized by comprising: supplying the photocurable resin composition at a predetermined thickness and irradiating the photocurable resin composition with light energy based on the slice data of a three-dimensional model to cure it.

19. The method for producing an article according to claim 17, characterized by further comprising washing or post-curing a shaped product obtained by repeating, multiple times, the supplying the photocurable resin composition at a predetermined thickness and the irradiating the photocurable resin composition with light energy to cure it.

20. A product obtained using the cured product according to claim 16, characterized in that the product is electrical and electronic equipment, office automation equipment, a camera or a computer.
